(19) United States
(12) Patent Application Publication
(10) Pub. No.: US 2013/0302547 A1
(43) Pub. Date: Nov. 14, 2013

(54) MICROSTRUCTURE FOR FUSION BONDED THERMOPLASTIC POLYMER MATERIAL, AND RELATED METHODS

(71) Applicants: Krishna V. Nadella, Redmond, WA (US); Vipin Kumar, Seattle, WA (US); Xiaoxi Wang, Mukilteo, WA (US); James Hanks, Seattle, WA (US)

(72) Inventors: Krishna V. Nadella, Redmond, WA (US); Vipin Kumar, Seattle, WA (US); Xiaoxi Wang, Mukilteo, WA (US); James Hanks, Seattle, WA (US)

(21) Appl. No.: 13/981,581

(22) PCT Filed: Jan. 27, 2012
(86) PCT No.: PCT/US12/22963

§ 371 Date: Jul. 24, 2013

Related U.S. Application Data
(60) Provisional application No. 61/436,902, filed on Jan. 27, 2011.

(51) Int. Cl. B32B 3/10

(52) U.S. Cl. CPC B32B 3/10
USPC 428/35.7; 428/314.8

(57) ABSTRACT

A material comprises a first layer that includes a thermoplastic polymer having a microstructure that includes a plurality of closed cells, each cell containing a void and each cell having a maximum dimension extending across the void within the cell that ranges between 1 micrometer and 200 micrometers long. The material also includes a second layer including a thermoplastic polymer having a microstructure that includes a plurality of closed cells, each cell containing a void and each cell having a maximum dimension extending across the void within the cell that ranges between 1 micrometer and 200 micrometers long. The material also includes an interface layer formed by fusion bonding the first layer to the second layer, the interface layer having a microstructure that includes a plurality of closed cells, each cell containing a void and each cell having a maximum dimension extending across the void within the cell that is at least 100 micrometers long.

### CROSS REFERENCE TO RELATED APPLICATION AND CLAIM OF PRIORITY

This application claims priority from commonly owned U.S. Provisional Patent Application 61/436,902 filed 27 Jan. 2011, and titled “Microstructures of Fusion-Bonded Microcellular Thermoplastic Articles”, presently pending, which is incorporated by reference.

### BACKGROUND

Articles made of a thermoplastic polymer material are sometimes fusion-bonded to each other to produce an article that is thicker and stronger than each of the articles before they are bonded together. For example, a panel made of polyethylene terephthalate (PET) may be made by fusion-bonding two sheets of PET together. Sometimes portions of an article of a thermoplastic polymer material are fusion-bonded together to change the shape of the article. For example, two ends of a sheet of a PET may be formed into a tube by fusion-bonding two ends of the sheet together. And sometimes portions of two or more articles of a thermoplastic material are fusion-bonded together to form a new article having a shape and strength that is different than the shape and strength of each of the individual articles before they are bonded together. For example, a convolute formed cup whose side is formed by fusion-bonding two ends of a flat blank to each other to form a truncated cone, and whose bottom is fusion-bonded to an end of the truncated cone. Fusion-bonding typically involves melting a portion of each material, mixing them together, then solidifying them.

Many articles of thermoplastic material include a microstructure that has many bubbles or voids. When articles having such a microstructure are fusion-bonded to another article or another portion of the same article, the microstructure in the bonded region often includes a layer of solid material (the fusion-bond) sandwiched between each article's bubble layer. Unfortunately, such a microstructure can be

### SUMMARY

In an aspect of the invention, a material comprises a first layer that includes a thermoplastic polymer having a microstructure that includes a plurality of closed cells, each cell containing a void and each cell having a maximum dimension extending across the void within the cell that ranges between 1 micrometer and 200 micrometers long. The material also includes a second layer including a thermoplastic polymer having a microstructure that includes a plurality of closed cells, each cell containing a void and each cell having a maximum dimension extending across the void within the cell that ranges between 1 micrometer and 200 micrometers long. The material also includes an interface layer formed by fusion bonding the first layer to the second layer, the interface layer having a microstructure that includes a plurality of closed cells, each cell containing a void and each cell having a maximum dimension extending across the void within the cell that is at least 100 micrometers long.

By including closed cells within the interface layer's microstructure, sudden changes in the amount of material in the material's cross-section can be mitigated, thus allowing the material to carry substantial tensile, compressive, and shear loads.

In another aspect of the invention, a cup comprises a seam that includes a first layer including a thermoplastic polymer having a microstructure that includes a plurality of closed cells, each cell containing a void and each cell having a maximum dimension extending across the void within the cell that ranges between 1 micrometer and 200 micrometers long. The seam also includes a second layer including a thermoplastic polymer having a microstructure that includes a plurality of

In yet another aspect of the invention, a panel comprises a body that includes a first layer including a thermoplastic polymer having a microstructure that includes a plurality of closed cells, each cell containing a void and each cell having a maximum dimension extending across the void within the cell that ranges between 1 micrometer and 200 micrometers long. The body also includes a second layer including a thermoplastic polymer having a microstructure that includes a plurality of closed cells, each cell containing a void and each cell having a maximum dimension extending across the void within the cell that ranges between 1 micrometer and 200 micrometers long. The body also includes an interface layer formed by fusion bonding the first layer to the second layer, the interface layer having a microstructure that includes a plurality of closed cells, each cell containing a void and each cell having a maximum dimension extending across the void within the cell that is at least 100 micrometers long.

### BRIEF DESCRIPTION OF THE FIGURES

FIG. 1 is a perspective view of a thermoplastic polymer material having a microstructure, according to an embodiment of the invention.

FIG. 2 is a photograph of a partial cross-section of a thermoplastic polymer material having a microstructure, according to an embodiment of the invention. The photograph shows the partial cross-section at a magnification of 300 times its actual size.

FIG. 3 is a photograph of a cross-section of a thermoplastic polymer material, according to another embodiment of the invention. The photograph shows the cross-section at a magnification of 35 times its actual size.

FIG. 4 is a photograph of a panel that includes a thermoplastic polymer material similar to the material shown in FIG. 3, according to an embodiment of the invention, and subjected to a bending test that causes severe deformation in the panel but does not cause delamination.

FIG. 5 is a perspective view of a cup, according to an embodiment of the invention.

FIG. 6 is a perspective view of a panel, according to another embodiment of the invention.

FIG. 7 is a perspective view of a thermoplastic polymer material having a microstructure, according to another embodiment of the invention.

### DETAILED DESCRIPTION

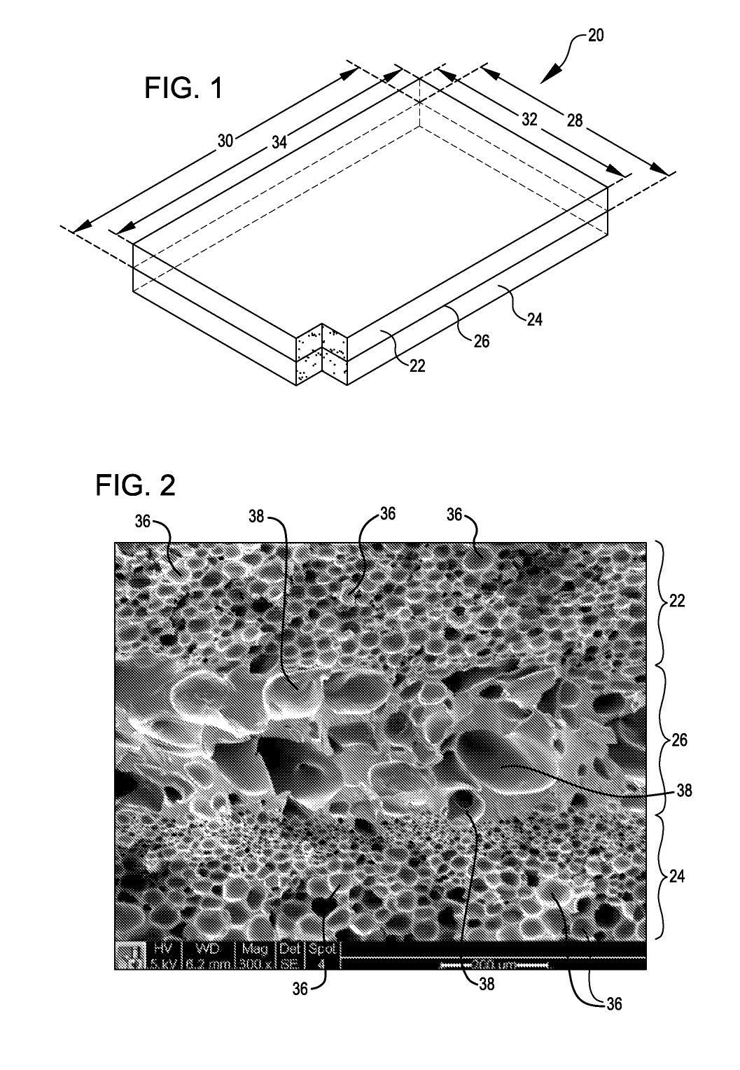

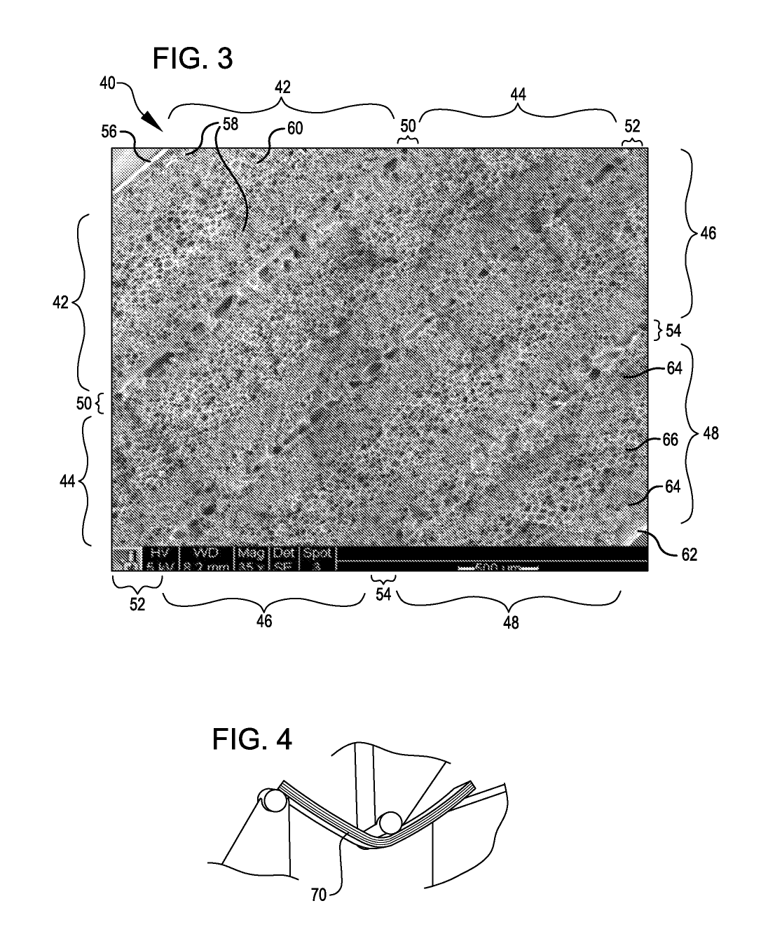

FIG. 1 is a perspective view of a thermoplastic polymer material 20 having a microstructure, according to an embodiment of the invention. Although the material 20 is shown in the form of a flat sheet or flat panel, the material 20 may be in any other desired form, such as a curved sheet similar to a bowl. The material 20 includes a first layer 22, a second layer 24 and an interface layer 26 that is formed by fusion bonding the first layer 22 to the second layer 24. The first and second layers 22 and 24, respectively, each include a thermoplastic polymer having a microstructure that includes a plurality of closed cells (discussed in greater detail in conjunction with FIGS. 2 and 3). Each closed cell contains a void and has a maximum dimension extending across the void within the cell that ranges between 1 micrometer (μm) and 200 μm long, inclusive. The interface layer 26 includes the thermoplastic polymer of the first and second layers 22 and 24, respectively, and has a microstructure that includes a plurality of closed cells (also discussed in greater detail in conjunction with FIGS. 2 and 3). Each closed cell in the interface layer 26 contains a void and has a maximum dimension extending across the void within the cell that is at least 100 micrometers (μm) long. By including closed cells within the interface layer's microstructure, sudden changes in the amount of material in the material's cross-section can be mitigated, thus allowing the material to carry a substantial tensile, compressive, and/or shear load.

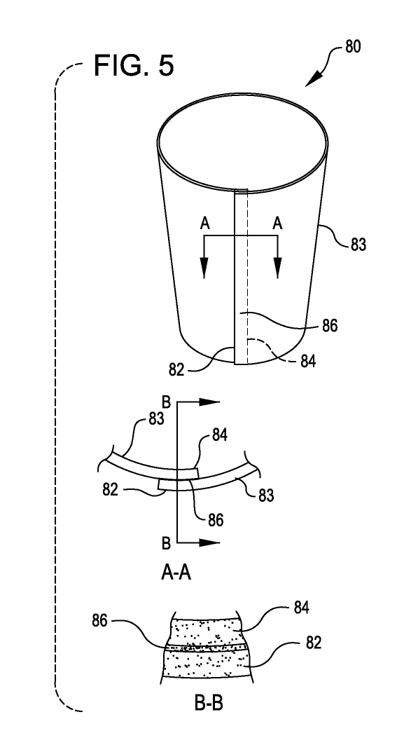

The first and second layers, 22 and 24, respectively, may be two separate pieces that are fusion bonded together, such as the separate pieces shown and discussed in conjunction with FIGS. 3, 4 and 6 that, when combined, form a panel of material. The first and second layers 22 and 24, respectively, may also be two separate portions of a single piece that are fusion bonded together, such as the separate portions of the single piece shown and discussed in conjunction with FIG. 5 that, when combined, form a cone of material. Furthermore, in this and other embodiments, the interface layer 26 may include a width 28 and a length 30 that is the same as the width 32 and the length 34 of the first layer 22. And in other embodiments, such as that shown in FIG. 7, the width 28 and/or the length 30 of the interface layer 26 may be less than the first layer's width 32 and/or the length 34, respectively.

Still referring to FIG. 1, the thermoplastic polymer included in the first and second layers 22 and 24, respectively, may be any desired thermoplastic polymer that provides the mechanical properties, such as tensile strength, compression strength, and/or shear strength, desired. For example, the thermoplastic polymer may be any amorphous or semi-crystalline thermoplastic. In this and other embodiments, the thermoplastic polymer included in the first layer 22 and the second layer 24 includes polyethylene terephthalate (PET).

Other embodiments are also possible. For example, the thermoplastic polymer included in the first layer 22 and the second layer 24 may include polystyrene, polycarbonate, acrylonitrile-butadiene-styrene, glycol modified PET, polyethylene, polypropylene, NORYL (a blend of polyphenylene oxide and polystyrene), and polyvinyl chloride. In yet other embodiments, the thermoplastic polymer included in the first layer 22 may be different than the thermoplastic polymer included in the second layer 24. In still other embodiments, the first layer 22 may include a combination or blend of thermoplastic polymers and the second layer 24 may include the same combination or blend of thermoplastic polymers, a different combination or blend of thermoplastic polymers, or a single thermoplastic polymer.

FIG. 2 is a photograph of a partial cross-section of the thermoplastic polymer material 20 having a microstructure, according to an embodiment of the invention.

The microstructure of each of the first and second layers 22 and 24, respectively, includes many closed cells 36 (only 6 labeled in FIG. 2 for clarity)—about 10⁸ or more per cubic centimeter (cm³). The size of each closed cell 36 ranges between 1 and 200 μm long at its maximum dimension that extends across the void. Because the geometry of each closed-cell is rarely, if at all, a perfect sphere, the size of each closed cell is arbitrarily identified as the length of the longest chord that extends through the void within the closed cell. For example, the size of an oblong cell would be the length of the longest chord that extends in the same direction as the cell's elongation, and the size of a sphere would be the length of the sphere's diameter.

In this and other embodiments, the many closed cells 36 included in the microstructure of the first layer 22 are uniformly dispersed throughout the thickness (a portion of which is shown in FIG. 2) of the first layer 22. And, the size of each of the closed cells 36 included in the first layer 22 ranges between 12 and 36 μm long at its maximum dimension that extends across the void. Furthermore, the many closed cells 36 included in the microstructure of the second layer 24 are also uniformly dispersed throughout the thickness (a portion of which is shown in FIG. 2) of the second layer 24. And, the size of each of the closed cells 36 included in the second layer 24 ranges between 12 and 36 μm long at its maximum dimension that extends across the void.

Other embodiments are possible. For example, the size of each of the closed cells 36 in both the first and the second layers 22 and 24, respectively, may be smaller than 12 μm long at its maximum dimension that extends across the void; or each may be larger than 36 μm long at its maximum dimension that extends across the void. As another example, the size of each of the closed cells 36 in the first layer 22 may have a size that is larger than or smaller than the size of each of the closed cells in the second layer 24. As another example, the closed cells include in the first layer 22, and/or the second layer 24 may be unevenly dispersed throughout the thickness of the respective first and second layers 22 and 24.

Still referring to FIG. 2, the microstructure of each of the first and second layers 22 and 24, respectively, may be generated by any desired process. For example, in this and other embodiments the microstructure of the first layer 22 and the microstructure of the second layer 24 are generated by a solid-state microcellular foaming process. Such a process includes dissolving into the thermoplastic polymer a gas that does not react with the polymer, making the polymer with the dissolved gas thermodynamically unstable at a temperature that is or close to the polymer and dissolved gas combination's glass transition temperature—the temperature at which the polymer is easily malleable but has not yet melted. With the temperature at or near the glass transition temperature, bubbles of the gas can nucleate and grow in regions of the polymer that are thermodynamically unstable—i.e. supersaturated. When the bubbles have grown to a desired size, the temperature of the polymer is reduced below the glass transition temperature to stop the bubbles' growth, and thus provide the polymer with a microstructure having closed-cells whose size may range between 1 and 200 μm long.

Still referring to FIG. 2, the microstructure of the interface layer 26, includes many closed cells 38 (only 3 labeled in FIG. 2 for clarity). The size of each closed cell 38 is at least 100 μm long at its maximum dimension that extends across the void. In this and other embodiments, the many closed cells 38 are uniformly dispersed throughout the thickness of the interface layer 26, and the size of each of the closed cells 38 ranges between 100 and 200 μm long at its maximum dimension that extends across the void.

Other embodiments are possible. For example, the size of each of the closed cells 38 may be larger than 200 μm long at its maximum dimension that extends across the void. As another example, the closed cells 38 may be unevenly dispersed throughout the thickness of the interface layer 26.

Still referring to FIG. 2, the microstructure of the interface layer 26 may be generated from a process of fusion bonding the first layer 22 to the second layer 24. In this and other embodiments, the fusion process includes the process disclosed in the currently pending PCT Patent Application No. PCT/US11/33075, titled “A METHOD FOR JOINING THERMOPLASTIC POLYMER MATERIAL”, filed 19 April

Several possible conditions, working alone or together, may account for the presence of the closed cells 38 in the interfacial layer 26. One such possible condition includes some of the residual gas from the solid-state microcellular foaming process used to generate the microstructure of the first and/or second layers 22 and 24, respectively, nucleating bubbles in the molten surface. The residual gas may migrate into the surfaces of the first and second layers 22 and 24 before the fusion bonding process begins. Then, when the surfaces with the dissolved gas are heated they become thermodynamically unstable, similar to the solid-state microcellular foaming process, and the dissolved gas nucleate and grow bubbles in the molten surface. Then, as the coalesced surfaces cool and harden, the bubbles stop growing and form the microstructure of the interfacial layer 26.

Alternatively or additionally, the residual gas from the solid-state microcellular foaming process used to generate the microstructure of the first and/or second layers 22 and 24, respectively, that is in the core of the layers 22 and 24 may migrate to the molten surface after the walls of some of the closed cells 36 have been softened or melted by the heat applied during the fusion process. When this occurs, the residual gas may get caught in the molten mixture where the gas begins to nucleate and grow bubbles. Then, as the coalesced surfaces cool and harden, the bubbles stop growing and form the microstructure of the interfacial layer 26.

Alternatively or additionally gas from the atmosphere or outside of the first and second layers 22 and 24, respectively, may enter the molten surfaces and nucleate and grow bubbles. Then, as the coalesced surfaces cool and harden, the bubbles stop growing and form the microstructure of the interfacial layer 26.

FIG. 3 is a photograph of a cross-section of a thermoplastic polymer material 40, according to another embodiment of the invention. The photograph shows the cross-section at a magnification of 35 times its actual size. The material 40 includes four layers 42, 44, 46 and 48, and three interfacial layers 50, 52, and 54, that together provide a material thicker than the material 20 in FIGS. 1 and 2.

In this and other embodiments, each of the interfacial layers 50, 52, and 54 includes many closed cells 38, the size of each being at least 100 μm long at its maximum dimension that extends across the void. Each of the layers 42-48 includes a sub-layer, and each sub-layer includes a microstructure having a plurality of closed cells each of which has a size at its maximum dimension that extends across the void, that is different than the size of the closed cells in an adjacent sub-layer. For example the layer 42 includes a skin sub-layer 56 that is solid—does not include a closed cell. The layer 42 also includes a sub-layer 58 that is adjacent the skin sub-layer 56 and the interface layer 50, and that has many closed cells, the size of each ranging between 12 and 24 μm long at its maximum dimension that extends across the void. The layer 42 also includes a sub-layer 60 that is between the two sub-layers 58, and that has many closed cells, the size of each ranging between 24 and 36 μm long at its maximum dimension that extends across the void. Similar to the layer 42, the layer 48 includes a skin sub-layer 62, two sub-layers 64, and a sub-layer 66. The two layers 44 and 46 are also similar to the layer 42 except the layers 44 and 46 do not include a skin sub-layer.

Other embodiments are possible. For example, the material 40 may include more than the three interfacial layers 50, 52 and 54, and more than the four layers 42, 44, 46 and 48. As other examples, each of the three interfacial layers 50, 52 and 54 may include different microstructures, such as larger or smaller closed cells than the other two interfacial layers. Similarly, each of the four layers 42, 44, 46 and 48 may include different microstructures, such as larger or smaller closed cells than the other three layers, or more or fewer sub-layers than the other three layers.

FIG. 4 is a photograph of a panel 70 that includes a thermoplastic polymer material similar to the material shown in FIG. 3, according to an embodiment of the invention, and subjected to a bending test that causes severe deformation in the

FIG. 5 is a perspective view of a cup 80, according to an embodiment of the invention. In this and other embodiments, the cup 80 is convolute formed by fusion bonding one end 82 of the cup's wall 83 to another end 84 to form a seam 86. Other embodiments are possible. For example a cup may be formed by nesting two or more thermoformed cups and then fusion bonding a portion of each of the nesting cups together.

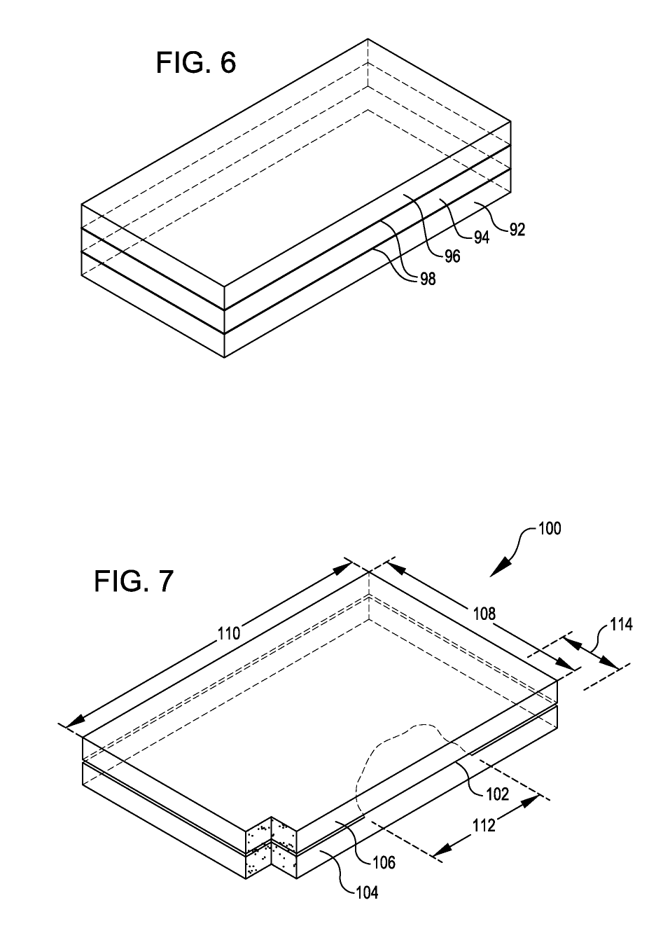

FIG. 6 is a perspective view of a panel 90, according to another embodiment of the invention. In this and other embodiments, the panel 90 is formed by fusion bonding three stacked layers 92, 94 and 96 together. Between each layer lies an interfacial layer 98. The panel may be used as a decorative wall covering or as a load carrying structural component.

FIG. 7 is a perspective view of a thermoplastic polymer material 100 having a microstructure, according to another embodiment of the invention. The material 100 is similar to the material 20 in FIG. 1 except that the interfacial layer 102 between the layers 104 and 106 does not extend the full length 108 or the full width 110 of the layers 104 and 106. For example, the width 112 of the interfacial layer 102 is less than the width of the layers 104 and 106, and the length 114 of the interfacial layer 102 is less than the length of the layers 104 and 106.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A material comprising:
a first layer including a thermoplastic polymer having a microstructure that includes a plurality of closed cells, each cell containing a void and each cell having a maximum dimension extending across the void within the cell that ranges between 1 micrometer and 200 micrometers long;
a second layer including a thermoplastic polymer having a microstructure that includes a plurality of closed cells, each cell containing a void and each cell having a maximum dimension extending across the void within the cell that ranges between 1 micrometer and 200 micrometers long; and
an interface layer formed by fusion bonding the first layer to the second layer, the interface layer having a microstructure that includes a plurality of closed cells, each cell containing a void and each cell having a maximum dimension extending across the void within the cell that is at least 100 micrometers long.

2. The material of claim 1 wherein:
the first layer includes a first thermoplastic polymer material,
the second layer includes a second thermoplastic polymer material, and
the first thermoplastic polymer material is different than the second thermoplastic polymer material.

3. The material of claim 1 wherein the maximum dimension of the void of each cell of the first layer's thermoplastic polymer ranges between 12 micrometers and 36 micrometers.

4. The material of claim 1 wherein:
the maximum dimension of the void of each cell of the first layer's thermoplastic polymer ranges between 12 micrometers and 36 micrometers, and
the maximum dimension of the void of each cell of the second layer's thermoplastic polymer ranges between 12 micrometers and 36 micrometers.

5. The material of claim 1 wherein the first layer includes a first sub-layer, a second sub-layer, and a third sub-layer wherein:
the first sub-layer has a microstructure that includes a plurality of closed cells, each cell containing a void and each cell having a maximum dimension extending across the void within the cell that ranges between 12 micrometers and 24 micrometers long,
the second sub-layer has a microstructure that includes a plurality of closed cells, each cell containing a void and each cell having a maximum dimension extending across the void within the cell that ranges between 24 micrometers and 36 micrometers long, and
the third sub-layer has a microstructure that includes a plurality of closed cells, each cell containing a void and each cell having a maximum dimension extending across the void within the cell that ranges between 12 micrometers and 24 micrometers long.

6. The material of claim 1 wherein each of the first and second layers includes a first sub-layer, a second sub-layer, and a third sub-layer wherein:
each of the first sub-layers has a microstructure that includes a plurality of closed cells, each cell containing a void and each cell having a maximum dimension extending across the void within the cell that ranges between 12 micrometers and 24 micrometers long,
each of the second sub-layers has a microstructure that includes a plurality of closed cells, each cell containing a void and each cell having a maximum dimension extending across the void within the cell that ranges between 24 micrometers and 36 micrometers long, and
each of the third sub-layers has a microstructure that includes a plurality of closed cells, each cell containing a void and each cell having a maximum dimension extending across the void within the cell that ranges between 12 micrometers and 24 micrometers long.

7. The material of claim 1 wherein the first layer's thermoplastic material includes polyethylene terephthalate (PET).

8. The material of claim 1 wherein the first layer's thermoplastic material includes polyethylene terephthalate (PET), and the second layer's thermoplastic material includes polyethylene terephthalate (PET).

9. The material of claim 1 wherein the microstructure of the first layer is formed by a solid-state microcellular foaming process.

10. The material of claim 1 wherein the microstructure of the first layer is formed by a solid-state microcellular foaming process, and the microstructure of the second layer is formed by a solid-state microcellular foaming process.

11. The material of claim 1 wherein the first layer has a width and a length, and the interface layer has the same width and the same length.

12. The material of claim 1 wherein:
the first layer has a width and a length, and
the interface layer has a width that is less than the width of the first layer, and a length that is less than the length of the first layer.

13. The material of claim 1 further comprising five or more layers.

14. A cup comprising:
a seam that includes:
a first layer including a thermoplastic polymer having a microstructure that includes a plurality of closed cells, each cell containing a void and each cell having a maximum dimension extending across the void within the cell that ranges between 1 micrometer and 200 micrometers long;
a second layer including a thermoplastic polymer having a microstructure that includes a plurality of closed cells, each cell containing a void and each cell having a maximum dimension extending across the void within the cell that ranges between 1 micrometer and 200 micrometers long; and
an interface layer formed by fusion bonding the first layer to the second layer, the interface layer having a microstructure that includes a plurality of closed cells, each cell containing a void and each cell having a maximum dimension extending across the void within the cell that is at least 100 micrometers long.

15. The cup of claim 14 wherein the formation of the cup includes convolute forming.

16. The cup of claim 14 wherein the formation of the cup includes thermoforming.

17. A panel comprising:
a body that includes:
a first layer including a thermoplastic polymer having a microstructure that includes a plurality of closed cells, each cell containing a void and each cell having a maximum dimension extending across the void within the cell that ranges between 1 micrometer and 200 micrometers long;
a second layer including a thermoplastic polymer having a microstructure that includes a plurality of closed cells, each cell containing a void and each cell having a maximum dimension extending across the void within the cell that ranges between 1 micrometer and 200 micrometers long; and
an interface layer formed by fusion bonding the first layer to the second layer, the interface layer having a microstructure that includes a plurality of closed cells, each cell containing a void and each cell having a maximum dimension extending across the void within the cell that is at least 100 micrometers long.
